(19) United States
(12) Patent Application Publication
(10) Pub. No.: US 2003/0187660 A1
(43) Pub. Date: Oct. 2, 2003

(54) Intelligent social agent architecture

(76) Inventor: Li Gong, San Francisco, CA (US)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/184,113

(22) Filed: Jun. 28, 2002

Related U.S. Application Data
(63) Continuation of application No. 10/134,679, filed on Apr. 30, 2002.
(60) Provisional application No. 60/359,348, filed on Feb. 26, 2002.

(51) Int. Cl. G10L 21/00

(52) U.S. Cl. 704/277

(57) ABSTRACT

An intelligent social agent is an animated computer interface agent with social intelligence that has been developed for a given application or type of applications and a particular user population. The social intelligence of the agent comes from the ability of the agent to be appealing, affective, adaptive, and appropriate when interacting with the user.

### CROSS REFERENCE TO RELATED APPLICATION

The present application claims priority from U.S. application Ser. No. 10/134,679, filed Apr. 30, 2002, and titled Intelligent Social Agents, and U.S. Provisional Application No. 60/359,348, filed Feb. 26, 2002, and titled Intelligent Mobile Personal Assistant, both of which are hereby incorporated by reference in their entirety for all purposes.

### TECHNICAL FIELD

This description relates to techniques for developing and using a computer interface agent to assist a computer system user.

### BACKGROUND

A computer system may be used to accomplish many tasks. A user of a computer system may be assisted by a computer interface agent that provides information to the user or performs a service for the user.

### SUMMARY

In one general aspect, an apparatus for implementing an intelligent social agent includes an information extractor, an adaptation engine, and an output generator. The information extractor is configured to access a user profile associated with the user, receive an input associated with a user, and extract context information from the received input. The adaptation engine is configured to receive the context information and the user profile from the information extractor and process the context information and the user profile to produce an adaptive output. The output generator is configured to receive the adaptive output and represent the adaptive output in the intelligent social agent.

Implementations may include one of more of the following features. For example, the information extractor may be configured to receive physiological data or application program information associated with the user. The information extractor may be configured to extract information about an affective state of the user from physiological information associated with the user, vocal analysis information associated with the user by extracting verbal content and analyzing speech characteristics of the user, or verbal information from the user. Extracting context information also may include extracting a geographical position of the user and extracting information based on the geographical position of the user by using a global positioning system. Extracting context information may include extracting information about the application context associated with the user or about a linguistic style of the user.

An output generator may be a verbal generator, the adaptation engine may be configured to produce a verbal expression, and the verbal generator may produce the verbal expression in the intelligent social agent. An output generator may be an affect generator, the adaptation engine may be configured to produce a facial expression, and the affect generator may produce the facial expression in the intelligent social agent. The output generator may be a multi-modal generator that represents an adaptive output in the intelligent social agent using at least one of two modes. One mode may be a verbal mode and another mode may be an affect mode. The adaptive engine may be configured to produce a facial expression and a verbal expression that is represented in the intelligent social agent by the multi-modal output generator. The adaptation engine may be configured to produce an emotional expression in the intelligent social agent.

Implementations of the techniques discussed above may include a mobile device for implementing an intelligent social agent that interacts with a user or other type of system.

The details of one or more of the implementations are set forth in the accompanying drawings and description below. Other features and advantages will be apparent from the descriptions and drawings, and from the claims.

### DESCRIPTION OF THE DRAWINGS

FIG. 1 is a block diagram of a programmable system for developing and using an intelligent social agent.

FIG. 2 is a block diagram of a computing device on which an intelligent social agent operates.

FIG. 3 is a block diagram illustrating an architecture of a social intelligence engine.

FIGS. 4A and 4B are flow charts of processes for extracting affective and physiological states of the user.

FIG. 5 is a flow chart of a process for adapting an intelligent social agent to the user and the context.

FIG. 6 is a flow chart of a process for casting an intelligent social agent.

Like reference symbols in the various drawings indicate like elements.

### DETAILED DESCRIPTION

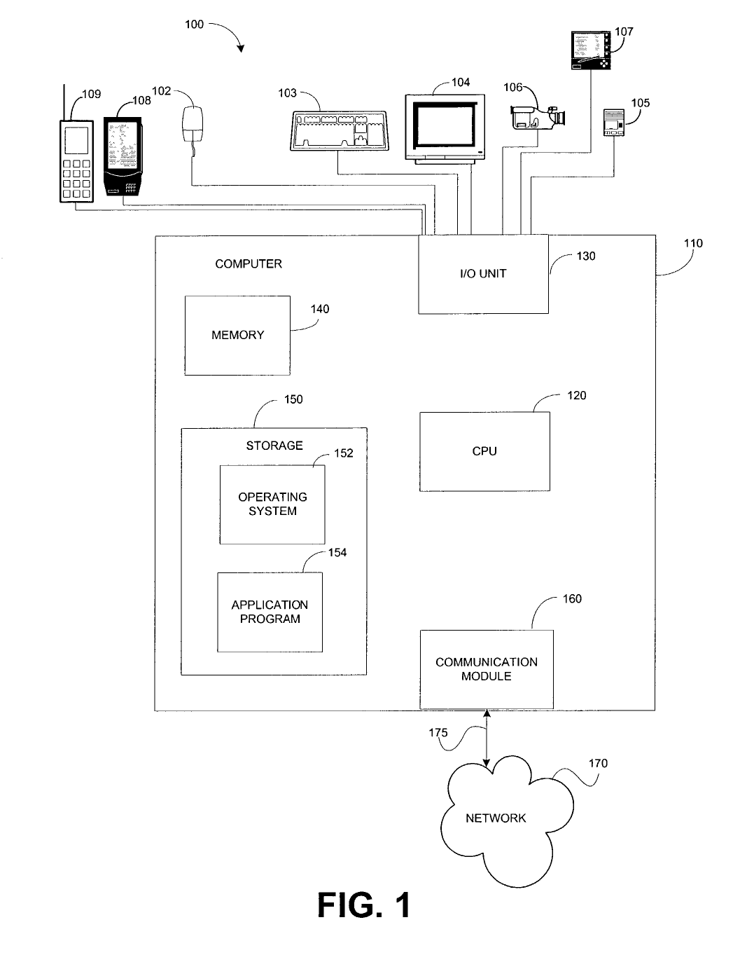

Referring to FIG. 1, a programmable system 100 for developing and using an intelligent social agent includes a variety of input/output (I/O) devices (e.g., a mouse 102, a keyboard 103, a display 104, a voice recognition and speech synthesis device 105, a video camera 106, a touch input device with stylus 107, a personal digital assistant or “PDA” 108, and a mobile phone 109) operable to communicate with a computer 110 having a central processor unit (CPU) 120, an I/O unit 130, a memory 140, and a data storage device 150. Data storage device 150 may store machine-executable instructions, data (such as configuration data or other types of application program data), and various programs such as an operating system 152 and one or more application programs 154 for developing and using an intelligent social agent, all of which may be processed by CPU 120. Each computer program may be implemented in a high-level procedural or object-oriented programming language, or in assembly or machine language if desired; and in any case, the language may be a compiled or interpreted language. Data storage device 150 may be any form of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM).

System 100 also may include a communications card or device 160 (e.g., a modem and/or a network adapter) for exchanging data with a network 170 using a communications link 175 (e.g., a telephone line, a wireless network link, a wired network link, or a cable network). Alternatively, a universal system bus (USB) connector may be used to connect system 100 for exchanging data with a network 170. Other examples of system 100 may include a handheld device, a workstation, a server, a device, or some combination of these capable of responding to and executing instructions in a defined manner. Any of the foregoing may be supplemented by, or incorporated in, ASICs (application-specific integrated circuits).

Although FIG. 1 illustrates a PDA and a mobile phone as being peripheral with respect to system 100, in some implementations, the functionality of the system 100 may be directly integrated into the PDA or mobile phone.

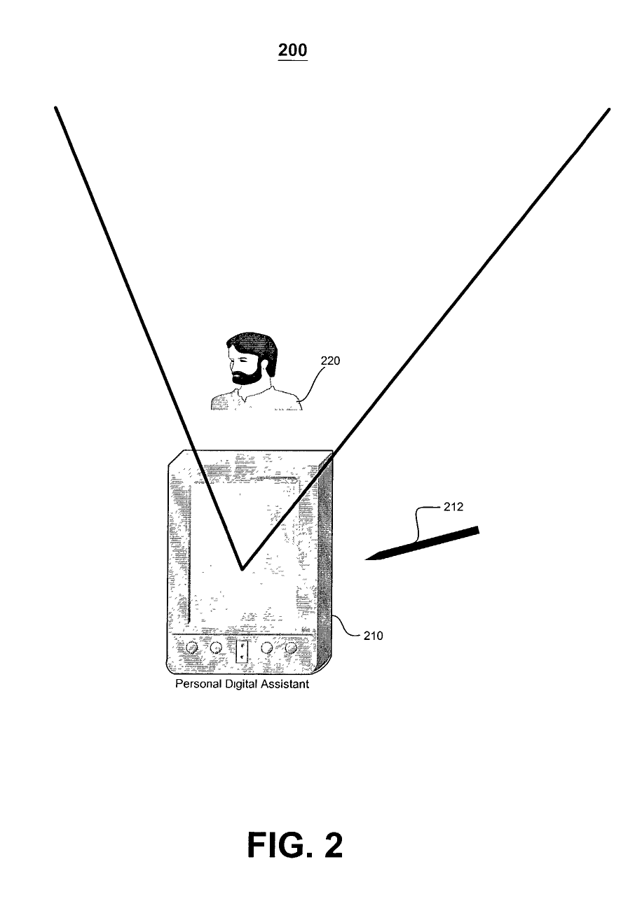

FIG. 2 shows an exemplary implementation of intelligent social agent 200 for a computing device including a PDA 210, a stylus 212, and a visual representation of a intelligent social agent 220. Although FIG. 2 shows an intelligent social agent as an animated talking head style character, an intelligent social agent is not limited to such an appearance and may be represented as, for example, a cartoon head, an animal, an image captured from a video or still image, a graphical object, or as a voice only. The user may select the parameters that define the appearance of the social agent. The PDA may be, for example, an iPAQ™ Pocket PC available from COMPAQ.

An intelligent social agent 200 is an animated computer interface agent with social intelligence that has been developed for a given application or device or a target user population. The social intelligence of the agent comes from the ability of the agent to be appealing, affective, adaptive, and appropriate when interacting with the user. Creating the visual appearance, voice, and personality of an intelligent social agent that is based on the personal and professional characteristics of the target user population may help the intelligent social agent be appealing to the target users. Programming an intelligent social agent to manifest affect through facial, vocal and linguistic expressions may help the intelligent social agent appear affective to the target users. Programming an intelligent social agent to modify its behavior for the user, application, and current context may help the intelligent social agent be adaptive and appropriate to the target users. The interaction between the intelligent social agent and the user may result in an improved experience for the user as the agent assists the user in operating a computing device or computing device application program.

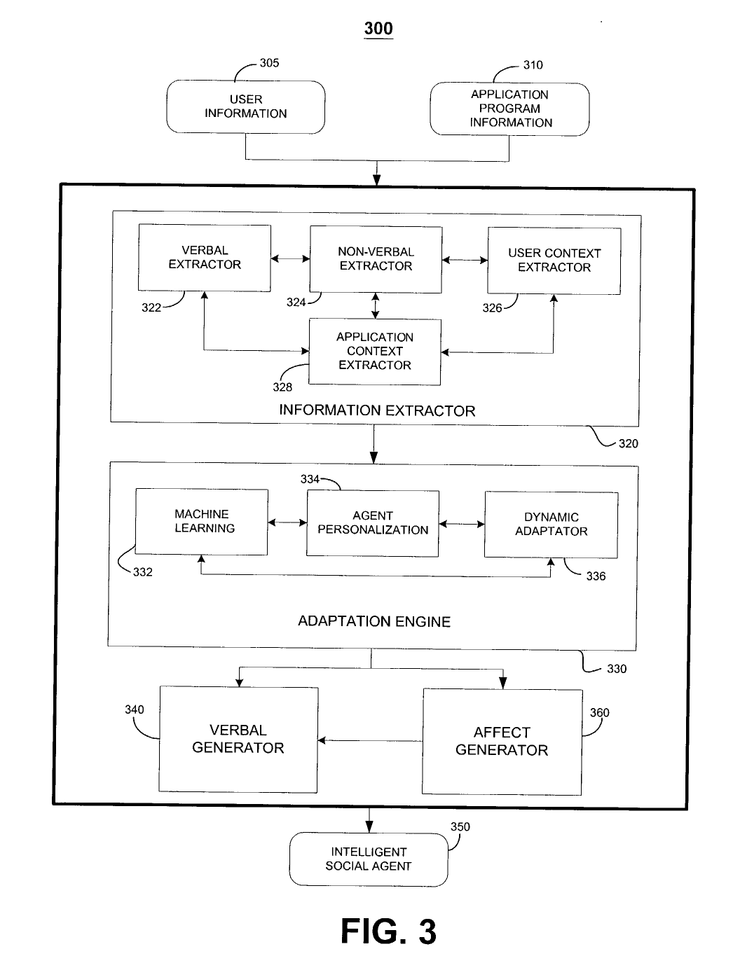

FIG. 3 illustrates an architecture of a social intelligence engine 300 that may enable an intelligent social agent to be appealing, affective, adaptive, and appropriate when interacting with a user. The social intelligence engine 300 receives information from and about the user 305 that may include a user profile, and from and about the application program 310. The social intelligence engine 300 produces behaviors and verbal and nonverbal expressions for an intelligent social agent.

The user may interact with the social intelligence engine 300 by speaking, entering text, using a pointing device, or using other types of I/O devices (such as a touch screen or vision tracking device). Text or speech may be processed by a natural language processing system and received by the social intelligence engine as a text input. Speech will be recognized by speech recognition software and may be processed by a vocal feature analyzer that provides a profile of the affective and physiological states of the user based on characteristics of the user's speech, such as pitch range and breathiness.

Information about the user may be received by the social intelligence engine 300. The social intelligence engine 300 may receive personal characteristics (such as name, age, gender, ethnicity or national origin information, and preferred language) about the user, and professional characteristics about the user (such as occupation, position of employment, and one or more affiliated organizations). The user information received may include a user profile or may be used by the central processor unit 120 to generate and store a user profile.

Non-verbal information received from a vocal feature analyzer or natural language processing system may include vocal cues from the user (such as fundamental pitch and speech rate). A video camera or a vision tracking device may provide non-verbal data about the user's eye focus, head orientation, and other body position information. A physical connection between the user and an I/O device (such as a keyboard, a mouse, a handheld device, or a touch pad) may provide physiological information (such as a measurement of the user's heart rate, blood pressure, respiration, temperature, and skin conductivity). A global positioning system may provide information about the user's geographic location. Other such contextual awareness tools may provide additional information about a user's environment, such as a video camera that provides one or more images of the physical location of the user that may be processed for contextual information, such as whether the user is alone or in a group, inside a building in an office setting, or outside in a park.

The social intelligence engine 300 also may receive information from and about an application program 310 running on the computer 110. The information from the application program 310 is received by the information extractor 320 of the social intelligence engine 300. The information extractor 320 includes a verbal extractor 322, a non-verbal extractor 324, and a user context extractor 326.

The verbal extractor 322 processes verbal data entered by the user. The verbal extractor may receive data from the I/O device used by the user or may receive data after processing (such as text generated by a natural language processing system from the original input of the user). The verbal extractor 322 captures verbal content, such as commands or data entered by the user for a computing device or an application program (such as those associated with the computer 110). The verbal extractor 322 also parses the verbal content to determine the linguistic style of the user, such as word choice, grammar choice, and syntax style.

The verbal extractor 322 captures verbal content of an application program, including functions and data. For example, functions in an email application program may include viewing an email message, writing an email message, and deleting an email message, and data in an email message may include the words included in a subject line, identification of the sender, time that the message was sent, and words in the email message body. An electronic commerce application program may include functions such as searching for a particular product, creating an order, and checking a product price and data such as product names, product descriptions, product prices, and orders.

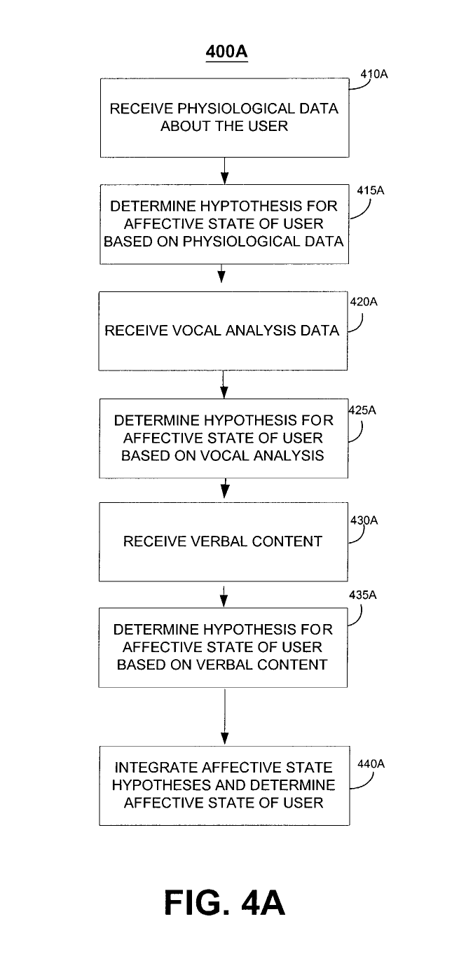

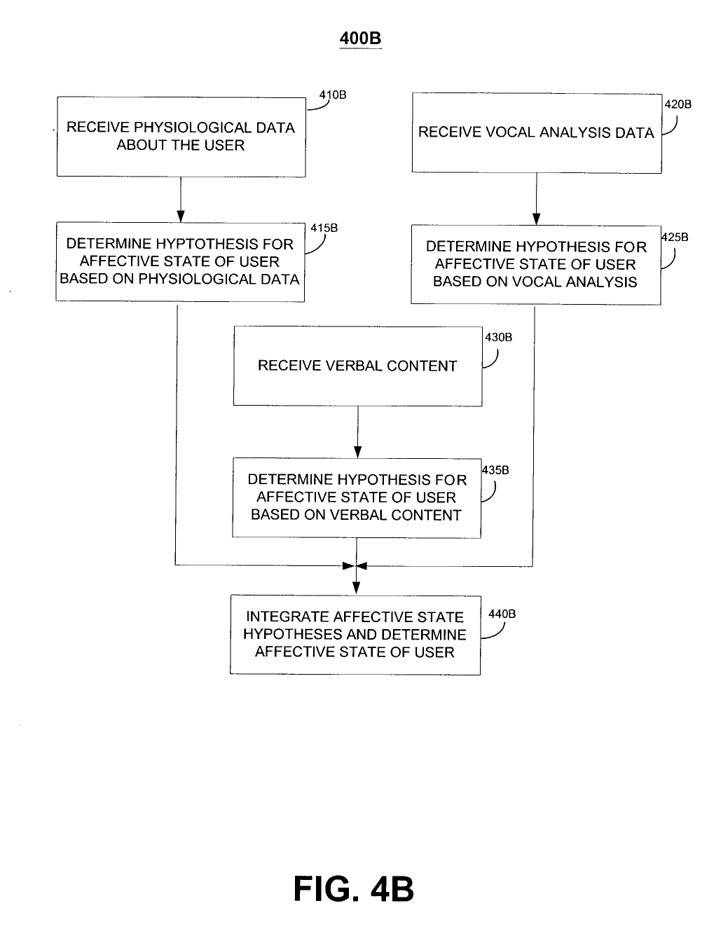

The nonverbal extractor 324 processes information about the physiological and affective states of the user. The nonverbal extractor 324 determines the physiological and affective states of the user from 1) physiological data, such as heart rate, blood pressure, blood pulse volume, respiration, temperature, and skin conductivity; 2) from the voice feature data such as speech rate and amplitude; and 3) from the user's verbal content that reveals affective information such as “I am so happy” or “I am tired”. Physiological data provide rich cues to induce a user's emotional state. For example, an accelerated heart rate may be associated with fear or anger and a slow heart rate may indicate a relaxed state. Physiological data may be determined using a device that attaches from the computer 110 to a user's finger and is capable of detecting the heart rate, respiration rate, and blood pressure of the user. The nonverbal extraction process is described in FIG. 4.

The user context extractor 326 determines the internal context and external context of the user. The user context extractor 326 determines the mode in which the user requests or executes an action (which may be referred to as internal context) based on the user's physiological data and verbal data. For example, the command to show sales figures for a particular period of time may indicate an internal context of urgency when the words are spoken with a faster speech rate, less articulation, and faster heart rate than when the same words are spoken with a normal style for the user. The user context extractor 326 may determine an urgent internal context from the verbal content of the command, such as when the command includes the term “quickly” or “now”.

The user context extractor 326 determines the characteristics for the user's environment (which may be referred to as the external context of the user). For example, a global positioning system (integrated within or connected to the computer 110) may determine the geographic location of the user from which the user's local weather conditions, geology, culture, and language may be determined. The noise level in the user's environment may be determined, for instance, through a natural language processing system or vocal feature analyzer stored on the computer 110 that processes audio data detected through a microphone integrated within or connected to the computer 110. By analyzing images from a video camera or vision tracking device, the user context extractor 326 may be able to determine other physical and social environment characteristics, such as whether the user is alone or with others, located in an office setting, or in a park or automobile.

The application context extractor 328 determines information about the application program context. This information may, for example, include the importance of an application program, the urgency associated with a particular action, the level of consequence of a particular action, the level of confidentiality of the application or the data used in the application program, frequency that the user interacts with the application program or a function in the application program, the level of complexity of the application program, whether the application program is for personal use or in an employment setting, whether the application program is used for entertainment, and the level of computing device resources required by the application program.

The information extractor 320 sends the information captured and compiled by the verbal extractor 322, the non-verbal extractor 324, the user context extractor 326, and the application context extractor 328 to the adaptation engine 330. The adaptation engine 330 includes a machine learning module 332, an agent personalization module 334, and a dynamic adaptor module 336.

The machine learning module 332 receives information from the information extractor 320 and also receives personal and professional information about the user. The machine learning module 332 determines a basic profile of the user that includes information about the verbal and non-verbal styles of the user, application program usage patterns, and the internal and external context of the user. For example, a basic profile of a user may include that the user typically starts an email application program, a portal, and a list of items to be accomplished from a personal information management system from after the computing device is activated, the user typically speaks with correct grammar and accurate wording, the internal context of the user is typically hurried, and the external context of the user has a particular level of noise and number of people. The machine learning module 332 modifies the basic profile of the user during interactions between the user and the intelligent social agent.

The machine learning module 332 compares the received information about the user and application content and context with the basic profile of the user. The machine learning module 332 may make the comparison using decision logic stored on the computer 110. For example, when the machine learning module 332 has received information that the heart rate of the user is 90 beats per minute, the machine learning module 332 compares the received heart rate with the typical heart rate from the basic profile of the user to determine the difference between the typical and received heart rates, and if the heart rate is elevated a certain number of beats per minute or a certain percentage, the machine learning module 332 determines the heart rate of the user is significantly elevated and a corresponding emotional state is evident in the user.

The machine learning module 332 produces a dynamic digest about the user, the application, the context, and the input received from the user. The dynamic digest may list the inputs received by the machine learning module 332, any intermediate values processed (such as the difference between the typical heart rate and current heart rate of the user), and any determinations made (such as the user is angry based on an elevated heart rate and speech change or semantics indicating anger). The machine learning module 332 uses the dynamic digest to update the basic profile of the user. For example, if the dynamic digest indicates that the user has an elevated heart rate, the machine learning module 332 may so indicate in the current physiological profile section of the user's basic profile. The agent personalization module 334 and the dynamic adaptor module 336 may also use the dynamic digest.

The agent personalization module 334 receives the basic profile of the user and the dynamic digest about the user from the machine learning module 332. Alternatively, the agent personalization module 334 may access the basic profile of the user or the dynamic digest about the user from the data storage device 150. The agent personalization module 334 creates a visual appearance and voice for an intelligent social agent (which may be referred to as casting the intelligent social agent) that may be appealing and appropriate for a particular user population and adapts the intelligent social agent to fit the user and the user's changing circumstances as the intelligent social agent interacts with the user (which may be referred to as personalizing the intelligent social agent).

The dynamic adaptor module 336 receives the adjusted basic profile of the user and the dynamic digest about the user from the machine learning module 332 and information received or compiled by the information extractor 320. The dynamic adaptor module 336 also receives casting and personalization information about the intelligent social agent from the agent personalization module 334.

The dynamic adaptor module 336 determines the actions and behavior of the intelligent social agent. The dynamic adaptor module 336 may use verbal input from the user and the application program context to determine the one or more actions that the intelligent social agent should perform. For example, when the user enters a request to “check my email messages” and the email application program is not activated, the intelligent social agent activates the email application program and initiates the email application function to check email messages. The dynamic adaptor module 336 may use nonverbal information about the user and contextual information about the user and the application program to help ensure that the behaviors and actions of the intelligent social agent are appropriate for the context of the user.

For example, when the machine learning module 332 indicates that the user's internal context is urgent, the dynamic adaptor module 336 may adjust the intelligent social agent so that the agent has a facial expression that looks serious and stops or pauses a non-critical function (such as receiving a large data file from a network) or closing unnecessary application programs (such as a drawing program) to accomplish a requested urgent action as quickly as possible.

When the machine learning module 332 indicates that the user is fatigued, the dynamic adaptor module 336 may adjust the intelligent social agent so that the agent has a relaxed facial expression, speaks more slowly, and uses words with fewer syllables, and sentences with fewer words.

When the machine learning module 332 indicates that the user is happy or energetic, the dynamic adaptor module 336 may adjust the intelligent social agent to have a happy facial expression and speak faster. The dynamic adaptor module 336 may have the intelligent social agent to suggest additional purchases or upgrades when the user is placing an order using an electronic commerce application program.

When the machine learning module 332 indicates that the user is frustrated, the dynamic adaptor module 336 may adjust the intelligent social agent to have a concerned facial expression and make fewer or only critical suggestions. If the machine learning module 332 indicates that the user is frustrated with the intelligent social agent, the dynamic adaptor module 336 may have the intelligent social agent apologize and explain sensibly what is the problem and how it should be fixed.

The dynamic adaptor module 336 may adjust the intelligent social agent to behave based on the familiarity of the user with the current computer device, application program, or application program function and the complexity of the application program. For example, when the application program is complex and the user is not familiar with the application program (e.g., the user is using an application program for the first time or the user has not used the application program for some predetermined period of time), the dynamic adaptor module 336 may have the intelligent social agent ask the user whether the user would like help, and, if the user so indicates, the intelligent social agent starts a help function for the application program. When the application program is not complex or the user is familiar with the application program, the dynamic adaptor module 336 typically does not have the intelligent social agent offer help to the user.

The verbal generator 340 receives information from the adaptation engine 330 and produces verbal expressions for the intelligent social agent 350. The verbal generator 340 may receive the appropriate verbal expression for the intelligent social agent from the dynamic adaptor module 336. The verbal generator 340 uses information from the machine learning module 332 to produce the specific content and linguistic style for the intelligent social agent 350.

The verbal generator 340 then sends the textual verbal content to an I/O device for the computer device, typically a display device, or a text-to-speech generation program that converts the text to speech and sends the speech to a speech synthesizer.

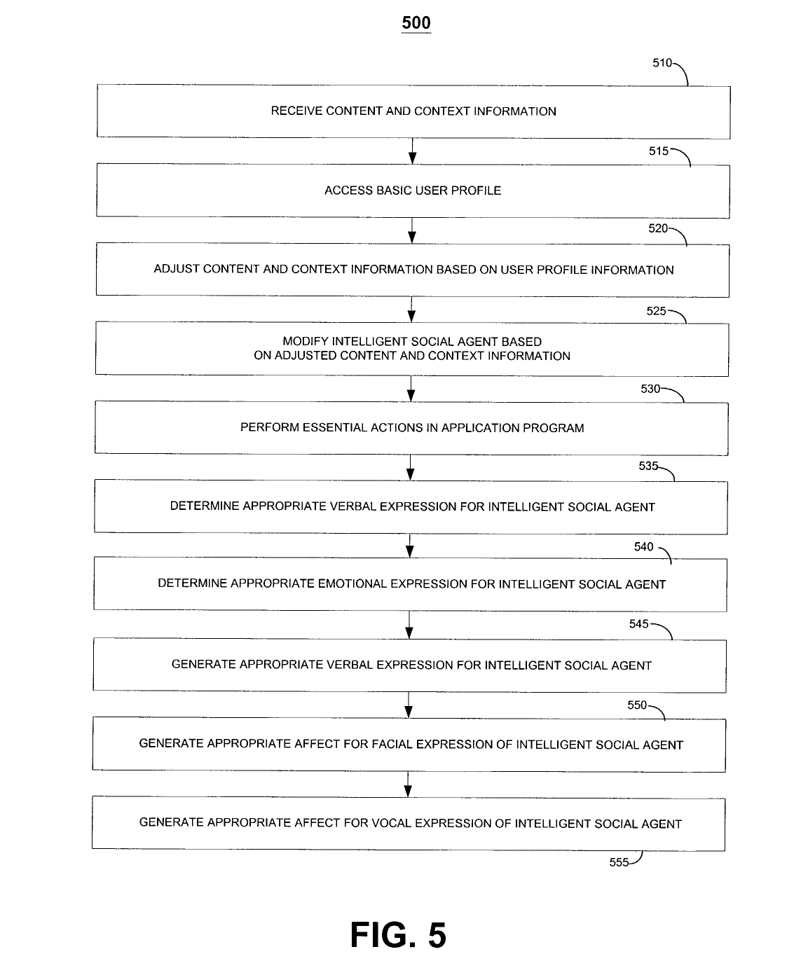

The affect generator 360 receives information from the adaptation engine 330 and produces the affective expression for the intelligent social agent 350. The affect generator 360 produces facial expressions and vocal expressions for the intelligent social agent 350 based on an indication from the dynamic adaptor module 336 as to what emotion the intelligent social agent 350 should express. A process for generating affect is described with respect to FIG. 5.

Referring to FIG. 4A, a process 400A controls a processor to extract nonverbal information and determine the affective state of the user. The process 400A is initiated by receiving physiological state data about the user (step 410A). Physiological state data may include autonomic data, such as heart rate, blood pressure, respiration rate, temperature, and skin conductivity. Physiological data may be determined using a device that attaches from the computer 110 to a user's finger or palm and is capable of detecting the heart rate, respiration rate, and blood pressure of the user.

The processor then tentatively determines a hypothesis for the affective state of the user based on the physiological data received through the physiological channel (step 415A). The processor may use predetermined decision logic that correlates particular physiological responses with an affective state. As described above with respect to FIG. 3, an accelerated heart rate may be associated with fear or anger and a slow heart rate may indicate a relaxed state.

The second channel of data received by the processor to determine the user's affective state is the vocal analysis data (step 420A), such as the pitch range, the volume, and the degree of breathiness in the speech of the user. For example, louder and faster speech compared to the user's basic pattern may indicate that a user is happy. Similarly, quieter and slower speech than normal may indicate that a user is sad. The processor then determines a hypothesis for the affective state of the user based on the vocal analysis data received through the vocal feature channel (step 425A).

The third channel of data received by the processor for determining the user's affective state is the user's verbal content that reveals the user's emotions (step 430A). Examples of such verbal content include phrases such as “Wow, this is great” or “What? The file disappeared?”. The processor then determines a hypothesis for the affective state of the user based on the verbal content received through the verbal channel (step 435A).

The processor then integrates the affective state hypotheses based on the data from the physiological channel, the vocal feature channel, and the verbal channel, resolves any conflict, and determines a conclusive affective state of the user (step 440A). Conflict resolution may be accomplished through predetermined decision logic. A confidence coefficient is given to the affective state predicted by each of the three channels based on the inherent predictive power of that channel for that particular emotion and the unambiguity level of the specific diagnosis of the emotional state in occurrence. Then the processor disambiguates by comparing and integrating the confidence coefficients.

Some implementations may receive either physiological data, vocal analysis data, verbal content, or a combination. When only one type of data is received, integration (step 440A) may not be performed. For example, when only physiological data is received, steps 420A-440A are not performed and the processor uses the affective state of the user based on physiological data as the affective state of the user. Similarly, when only vocal analysis data is received, the process is initiated when vocal analysis data is received and steps 410A, 415A, and 430A-445A are not performed. The processor uses the affective state of the user based on vocal analysis data as the affective state of the user.

Similarly, referring to FIG. 4B, a process 400B controls a processor to extract nonverbal information and determine the affective state of the user. The processor receives physiological data about the user (step 410B), vocal analysis data (step 420B), and verbal content that indicates the emotion of the user (step 430B) and determines a hypothesis for the affective state of the user based on each type of data (steps 415B, 425B, and 435B) in parallel. The processor then integrates the affective state hypotheses based on the data from the physiological channel, the vocal feature channel, and the verbal channel, resolves any conflict, and determines a conclusive affective state of the user (step 440B) as described with respect to FIG. 4A.

Referring to FIG. 5, a process 500 controls a processor to adapt an intelligent social agent to the user and the context. The process 500 may help an intelligent social agent to act appropriately based on the user and the application context.

The process 500 is initiated when content and contextual information is received (step 510) by the processor from an input/output device (such as a voice recognition and speech synthesis device, a video camera, or physiological detection device connected to a finger of the user) to the computer 110. The content and contextual information received may be verbal information, nonverbal information, or contextual information received from the user or application program or may be information compiled by an information extractor (as described previously with respect to FIG. 3).

The processor then accesses data storage device 150 to determine the basic user profile for the user with whom the intelligent social agent is interacting (step 515). The basic user profile includes personal characteristics (such as name, age, gender, ethnicity or national origin information, and preferred language) about the user, professional characteristics about the user (such as occupation, position of employment, and one or more affiliated organizations), and non-verbal information about the user (such as linguistic style and physiological profile information). The basic user profile information may be received during a registration process for a product that hosts an intelligent social agent or by a casting process to create an intelligent social agent for a user and stored on the computing device.

The processor may adjust the context and content information received based on the basic user profile information (step 520). For example, a verbal instruction to “read email messages now” may be received. Typically, a verbal instruction modified with the term “now” may result in a user context mode of “urgent.” However, when the basic user profile information indicates that the user typically uses the term “now” as part of an instruction, the user context mode may be changed to “normal”.

The processor may adjust the content and context information received by determining the affective state of the user. The affective state of the user may be determined from content and context information (such as physiological data or vocal analysis data).

The processor modifies the intelligent social agent based on the adjusted content and context information (step 525). For example, the processor may modify the linguistic style and speech style of the intelligent social agent to be more similar to the linguistic style and speech style of the user.

The processor then performs essential actions in the application program (step 530). For example, when the user enters a request to “check my email messages” and the email application program is not activated, the intelligent social agent activates the email application program and initiates the email application function to check email messages (as described previously with respect to FIG. 3).

The processor determines the appropriate verbal expression (step 535) and an appropriate emotional expression for the intelligent social agent (step 540) that may include a facial expression.

The processor generates an appropriate verbal expression for the intelligent social agent (step 545). The appropriate verbal expression includes the appropriate verbal content and appropriate emotional semantics based on the content and contextual information received, the basic user profile information, or a combination of the basic user profile information and the content and contextual information received.

For example, words that have affective connotation may be used to match the appropriate emotion that the agent should express. This may be accomplished by using an electronic lexicon that associates a word with an affective state, such as associating the word “fantastic” with happiness, the word “delay” with frustration, and so on. The processor selects the word from the lexicon that is appropriate for the user and the context. Similarly, the processor may increase the number of words used in a verbal expression when the affective state of the user is happy or may decrease the number of words used or use words with fewer syllables if the affective state of the user is sad.

The processor may send the verbal expression text to an I/O device for the computer device, typically a display device. The processor may convert the verbal expression text to speech and output the speech. This may be accomplished using a text-to-speech conversion program and a speech synthesizer.

In the meantime, the processor generates an appropriate affect for the facial expression of the intelligent social agent (step 550). Otherwise, a default facial expression may be selected. A default facial expression may be determined by the application, the role of the agent, and the target user population. In general, an intelligent social agent by default may be slightly friendly, smiling, and pleasant.

Facial emotional expressions may be accomplished by modifying portions of the face of the intelligent social agent to show affect. For example, surprise may be indicated by showing the eyebrows raised (e.g., curved and high), skin below brow stretched horizontally, wrinkles across forehead, eyelids opened, and the white of the eye is visible, jaw open without tension or stretching of the mouth.

Fear may be indicated by showing the eyebrows raised and drawn together, forehead wrinkles drawn to the center of the forehead, upper eyelid is raised and lower eyelid is drawn up, mouth open, and lips slightly tense or stretched and drawn back. Disgust may be indicated by showing upper lip is raised, lower lip is raised and pushed up to upper lip or lower lip is lowered, nose is wrinkled, cheeks are raised, lines appear below the lower lid, lid is pushed up but not tense, and brows are lowered. Anger may be indicated by eyebrows lowered and drawn together, vertical lines between eyebrows, lower lid is tensed, upper lid is tense, eyes have a hard stare, and eyes have a bulging appearance, lips are either pressed firmly together or tensed in a square shape, nostrils may be dilated. Happiness may be indicated by the corners of the lips being drawn back and up, a wrinkle is shown from the nose to the outer edge beyond the lip corners, cheeks are raised, lower eyelid shows wrinkles below it, lower eyelid may be raised but not tense, and crow's-feet wrinkles go outward from the outer corners of the eyes. Sadness may be indicated by drawing the inner corners of eyebrows up, triangulating the skin below the eyebrow, the inner corner of the upper lid and upper corner is raised, and corners of the lips are drawn or lip is trembling.

The processor then generates the appropriate affect for the verbal expression of the intelligent social agent (step 555). This may be accomplished by modifying the speech style from the baseline style of speech for the intelligent social agent. Speech style may include speech rate, pitch average, pitch range, intensity, voice quality, pitch changes, and level of articulation. For example, a vocal expression may indicate fear when the speech rate is much faster, the pitch average is very much higher, the pitch range is much wider, the intensity of speech normal, the voice quality irregular, the pitch change is normal, and the articulation precise. Speech style modifications that may connote a particular affective state are set forth in the table below and are further described in Murray, I. R., & Arnott, J. L. (1993), Toward the simulation of emotion in synthetic speech: A review of the literature on human vocal emotion, Journal of Acoustical Society of America, 93, 1097-1108.

| | Fear | Anger | Sadness | Happiness | Disgust |
|---|---|---|---|---|---|
| Speech | Much | Slightly | Slightly | Faster Or | Very Much |
| Rate | Faster | Faster | Slower | Slower | Slower |
| Pitch | Very | Very | Slightly | Much | Very Much |
| Average | Much | Much | Lower | Higher | Lower |
| | Higher | Higher | | | |
| Pitch | Much | Much | Slightly | Much | Slightly |
| Range | Wider | Wider | Narrower | Wider | Wider |
| Intensity | Normal | Higher | Lower | Higher | Lower |
| Voice | Irregular | Breathy | Resonant | Breathy | Grumbled |
| Quality | Voicing | Chest | | Blaring | Chest |
| | | Tone | | | Tone |
| Pitch | Normal | Abrupt On | Down- | Smooth | Wide |
| Changes | | Stressed | ward | Upward | Downward |
| | | Syllables | Inflections | Inflections | Terminal |
| | | | | | Inflections |
| Arti- | Precise | Tense | Slurring | Normal | Normal |
| culation | | | | | |

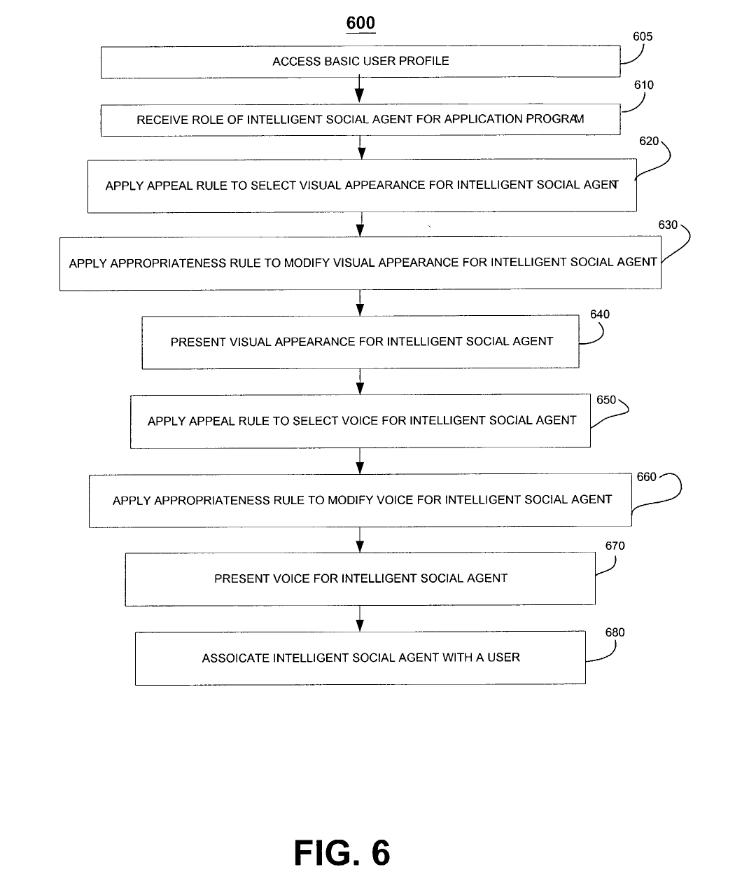

Referring to FIG. 6, a process 600 controls a processor to create an intelligent social agent for a target user population. This process (which may be referred to as casting an intelligent social agent) may produce an intelligent social agent whose appearance and voice are appealing and appropriate for the target users.

The process 600 begins with the processor accessing user information stored in the basic user profile (step 605). The user information stored within the basic user profile may include personal characteristics (such as name, age, gender, ethnicity or national origin information, and preferred language) about the user and professional characteristics about the user (such as occupation, position of employment, and one or more affiliated organizations).

The processor receives information about the role of the intelligent social agent for one or more particular application programs (step 610). For example, the intelligent social agent may be used as a help agent to provide functional help information about an application program or may be used as an entertainment player in a game application program.

The processor then applies an appeal rule to further analyze the basic user profile and to select a visual appearance for the intelligent social agent that may be appealing to the target user population (step 620). The processor may apply decision logic that associates a particular visual appearance for an intelligent social agent with particular age groups, occupations, gender, or ethnic or cultural groups. For example, decision logic may be based on similarity-attraction (that is, matching the ages, personalities, and ethnical identities of the intelligent social agent and the user). A professional-looking talking-head may be more appropriate for an executive user (such as a chief executive officer or a chief financial officer), and a talking-head with an ultra-modem hair style may be more appealing to an artist.

The processor applies an appropriateness rule to further analyze the basic user profile and to modify the casting of the intelligent social agent (step 630). For example, a male intelligent social agent may be more suitable for technical subject matter, and a female intelligent social agent may be more appropriate for fashion and cosmetics subject matter.

The processor then presents the visual appearance for the intelligent social agent to the user (step 640). Some implementations may allow the user to modify attributes (such as the hair color, eye color, and skin color) of the intelligent social agent or select from among several intelligent social agents with different visual appearances. Some implementations also may allow a user to import a graphical drawing or image to use as the visual appearance for the intelligent social agent.

The processor applies the appeal rule to the stored basic user profile (step 650) and the appropriateness rule to the stored basic user profile to select a voice for the intelligent social agent (step 660). The voice should be appealing to the user and be appropriate for the gender represented by the visual intelligent social agent (e.g., an intelligent social agent with a male visual appearance has a male voice and an intelligent social agent with a female visual appearance has a female voice). The processor may match the user's speech style characteristics (such as speech rate, pitch average, pitch range, and articulation) as appropriate for the voice of the intelligent social agent.

The processor presents the voice choice for the intelligent social agent (step 670). Some implementations may allow the user to modify the speech characteristics for the intelligent social agent.

The processor then associates the intelligent social agent with the particular user (step 680). For example, the processor may associate an intelligent social agent identifier with the intelligent social agent, store the intelligent social agent identifier and characteristics of the intelligent social agent in the data storage device 150 of the computer 110 and store the intelligent social agent identifier with the basic user profile. Some implementations may cast one or more intelligent social agents to be appropriate for a group of users that have similar personal or professional characteristics.

Implementations may include a method or process, an apparatus or system, or computer software on a computer medium. It will be understood that various modifications may be made without departing from the spirit and scope of the following claims. For example, advantageous results still could be achieved if steps of the disclosed techniques were performed in a different order and/or if components in the disclosed systems were combined in a different manner and/or replaced or supplemented by other components.

What is claimed is:

1. An apparatus for implementing an intelligent social agent, the apparatus comprising:
an information extractor configured to:
access a user profile associated with the user,
receive an input associated with a user, and
extract context information from the received input;
an adaptation engine configured to:
receive the context information and the user profile from the information extractor, and process the context information and the user profile to produce an adaptive output; and
an output generator configured to:
receive the adaptive output from the adaptation engine, and represent the adaptive output in the intelligent social agent.

2. The apparatus of claim 1 wherein the input is physiological data associated with the user and the information extractor is configured to receive the physiological data.

3. The apparatus of claim 1 wherein the input is application program information associated with the user and the information extractor is configured to receive application program information associated with the user.

4. The apparatus of claim 1 wherein the information extractor is further configured to extract information about an affective state of the user from the received input.

5. The apparatus of claim 4 wherein the information extractor is configured to extract information about an affective state of the user based on physiological information associated with the user.

6. The apparatus of claim 4 wherein the information extractor configured to extract information about an affective state of the user is configured to extract information about an affective state of the user based on vocal analysis information associated with the user by extracting verbal content and analyzing speech characteristics of the user.

7. The apparatus of claim 4 wherein the information extractor configured to extract information about an affective state of the user is configured to extract information about an affective state of the user based on verbal information from the received input.

8. The apparatus of claim 1 wherein the information extractor configured to extract context information is configured to extract a geographical position of the user by using a global positioning system.

9. The apparatus of claim 8 wherein the information extractor configured to extract context information is configured to extract information based on the geographical position of the user.

10. The apparatus of claim 1 wherein the information extractor configured to extract context information is configured to extract information about the application content associated with the user.

11. The apparatus of claim 1 wherein the information extractor configured to extract context information is configured to extract information about a linguistic style of the user from the received input.

12. The apparatus of claim 1 wherein:
the output generator is a verbal generator;
the adaptation engine configured to produce an adaptive output is configured to produce a verbal expression; and
the verbal generator produces the verbal expression in the intelligent social agent.

13. The apparatus of claim 1 wherein:
the generator is an affect generator;
the adaptation engine configured to produce an adaptive output is configured to produce a facial expression; and
the affect generator represents the facial expression in the intelligent social agent.

14. The apparatus of claim 1 wherein the output generator is a multi-modal output generator that represents the adaptive output in the intelligent social agent using at least one of a first mode and a second mode.

15. The apparatus of claim 14 wherein:
the first mode is a verbal mode;
the second mode is an affect mode;
the adaptive engine configured to produce an adaptive output is configured to:
produce a facial expression, and
produce an verbal expression; and
the multi-modal output generator represents the facial expression and the verbal expression in the intelligent social agent.

16. The apparatus of claim 1 wherein:
the adaptation engine is further configured to produce an emotional expression to be represented by the intelligent social agent; and
the output generator is configured to represent the emotional expression in the intelligent social agent.

17. A mobile device for implementing an intelligent social agent that interacts with a user, the mobile device comprising:
a processor connected to a memory and one or more input/output devices;
a social intelligence engine configured to interact with the processor, the social intelligence engine including:
an information extractor configured to:
access a user profile associated with the user,
receive an input associated with a user, and
extract context information from the received input;
an adaptation engine configured to:
receive the context information and the user profile from the information extractor, and process the context information and the user profile to produce an adaptive output; and
an output generator configured to:
receive the adaptive output from the adaptation engine, and represent the adaptive output in the intelligent social agent.

18. The mobile device of claim 17 wherein the input is physiological data associated with the user and the information extractor is configured to receive the physiological data.

19. The mobile device of claim 17 wherein the input is application program information associated with the user and the information extractor is configured to receive the application program information.

20. The mobile device of claim 17 wherein the information extractor is further configured to extract information about an affective state of the user from the received input.

21. The mobile device of claim 20 wherein the information extractor is configured to extract information about an affective state of the user based on physiological information associated with the user.

22. The mobile device of claim 20 wherein the information extractor configured to extract information about an affective state of the user is configured to extract information about an affective state of the user based on vocal analysis information associated with the user by extracting verbal content and analyzing speech characteristics of the user from the received input.

23. The mobile device of claim 20 wherein the information extractor configured to extract information about an affective state of the user is configured to extract information about an affective state of the user based on verbal information from the received input.

24. The mobile device of claim 17 wherein the information extractor configured to extract context information is configured to extract a geographical position of the user by using a global positioning system.

25. The mobile device of claim 24 wherein the information extractor configured to extract context information is configured to extract information based on the geographical position of the user.

26. The mobile device of claim 17 wherein information extractor configured to extract context information is configured to extract information about the application content associated with the user.

27. The mobile device of claim 17 wherein information extractor configured to extract context information is configured to extract information about a linguistic style of the user from the received input.

28. The mobile device of claim 17 wherein:
the output generator is a verbal generator;
the adaptation engine configured to produce an adaptive output is configured to produce a verbal expression; and
the verbal generator produces the verbal expression in the intelligent social agent.

29. The mobile device of claim 17 wherein:
the generator is an affect generator;
the adaptation engine configured to produce an adaptive output is configured to produce a facial expression; and
the affect generator represents the facial expression in the intelligent social agent.

30. The mobile device of claim 17 wherein the output generator is a multi-modal output generator that represents the adaptive output in the intelligent social agent using at least one of a first mode and a second mode.

31. The mobile device of claim 30 wherein:
the first mode is a verbal mode;
the second mode is an affect mode;
the adaptive engine configured to produce an adaptive output is configured to:
produce a facial expression, and
produce an verbal expression; and
the multi-modal output generator represents the facial expression and the verbal expression in the intelligent social agent.

32. The mobile device of claim 17 wherein:
the adaptation engine is further configured to produce an emotional expression to be represented by the intelligent social agent; and
the output generator is configured to represent the emotional expression in the intelligent social agent.
